(19) United States
(12) Patent Application Publication
(10) Pub. No.: US 2014/0212125 A1
(43) Pub. Date: Jul. 31, 2014

(54) CAMERA MODULE

(71) Applicant: INGRASYS TECHNOLOGY INC., Taoyuan (TW)

(72) Inventors: MING-CHIH HSIEH, Taoyuan (TW); CHI-YUAN CHEN, Taoyuan (TW)

(73) Assignee: INGRASYS TECHNOLOGY INC., Taoyuan (TW)

(21) Appl. No.: 13/849,548

(22) Filed: Mar. 25, 2013

(30) Foreign Application Priority Data
Jan. 29, 2013 (TW) 102103344

(51) Int. Cl. G03B 17/12

(52) U.S. Cl. CPC G03B 17/12
USPC 396/533; 396/529

(57) ABSTRACT

A camera module includes a main body, a lens module, and a connecting member mounted between the main body and the lens module. The lens module includes a cable connected to the main body. The connecting member includes a cable position structure for positioning the cable.

### BACKGROUND

1. Technical Field

The present disclosure relates to a camera module.

2. Description of Related Art

Camera modules generally include a main body and a lens module connected to the main body. The lens module includes a cable electrically connected to the main body. However, the lens module can be obstructed by the cable.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a camera module, wherein the camera module includes a connecting member.

FIG. 2 is an enlarged, isometric view of the connecting member of FIG. 1, but viewed from another perspective.

FIG. 3 is an assembled, isometric view of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

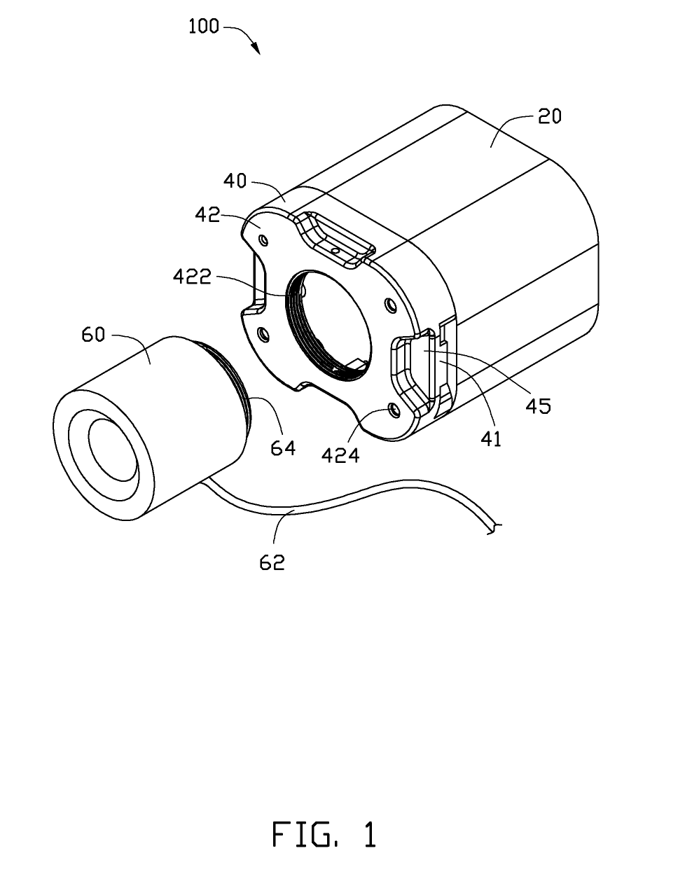

FIG. 1 shows an embodiment of a camera module 100 including a main body 20, a connecting member 40, and a lens module 60. The lens module 60 includes a cable 62 for electrically connecting the lens module 60 to the main body 20, and a tube-shaped connecting portion 64 extending out from a rear end of the lens module 60. The connecting portion 64 defines external threads.

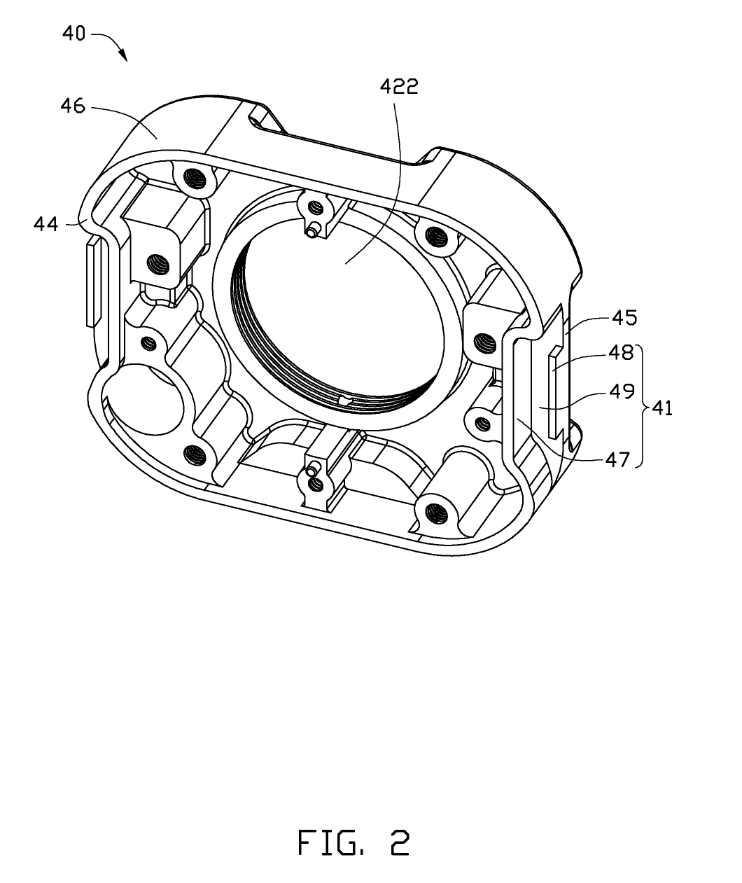

FIG. 2 shows the connecting member 40 including a substantially rectangular front plate 42, and four side plates 46 perpendicularly extending rearward from sides of the front plate 42. The front plate 42 defines a circular opening 422 in a center thereof, and four mounting holes 424 in four corners of the front plate 42. An inner wall bounding the opening 422 defines internal threads for mating with the external threads of the connecting portion 64. Two opposite cable position structures 41 are formed on two opposite side plates 46. Each cable position structure 41 includes an indentation 47 defined in a middle of the side plate 46 and extending through the front plate 42 and a rear surface of the side plate 46, a supporting plate 45 extending out from an inner surface of the indentation 47 and parallel to the front plate 46, and a flange 48 perpendicularly extending rearward from an outer side of the supporting plate 45 away from the front plate 46. The supporting plate 45, the flange 48, and the corresponding side plate 46 cooperatively bound a receiving slot 49 communicating with the corresponding indentation 47.

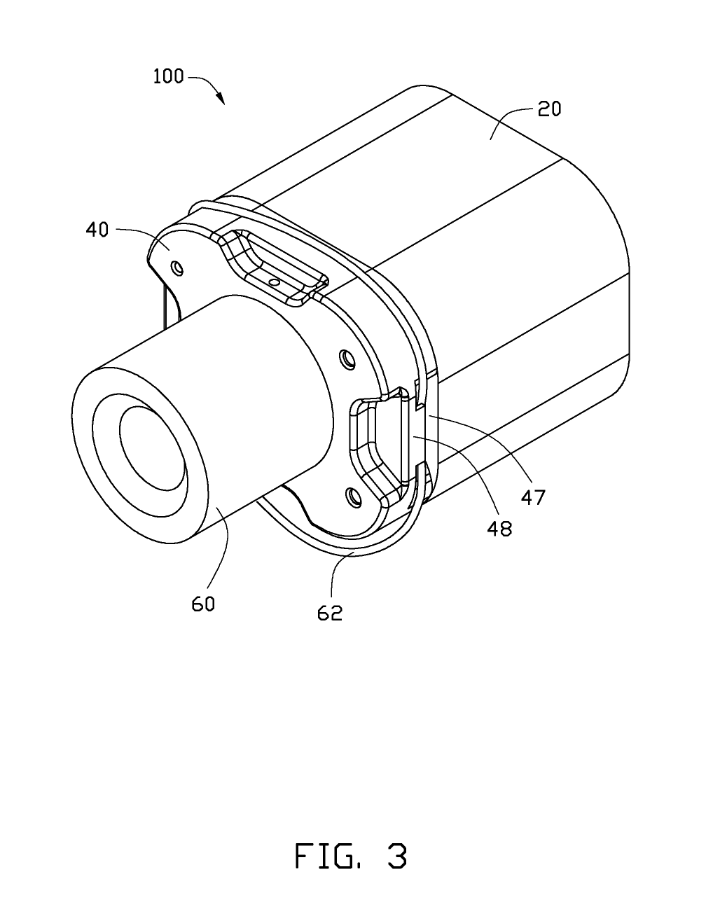

Referring to FIG. 3, in assembly, the rear surfaces of the side plates 46 of the connecting member 40 opposite to the front plate 42 are abutted against a front end surface of the main body 20. Four screws are extended through the mounting holes 424 of the connecting member 40, and are screwed into the main body 20. The connecting portion 64 of the lens module 60 is screwed into the opening 422 of the connecting member 40, with the external threads of the connecting portion 64 mating with the internal threads of the connecting member 40.

In use, a portion of the cable 62 adjacent to the lens module 60 is positioned in one of the receiving slots 49 of the connecting member 40. The cable 62 is wrapped around the side plates 46, until a portion of the cable 62 away from the lens module 60 is positioned in the other receiving slot 49 of the connecting member 40. The cable 62 is electrically connected to the main body 20. Therefore, the cable 62 is positioned by the cable position structures 41.

While the disclosure describes examples and embodiments, it is to be understood that the disclosure is not limited thereto. On the contrary, the disclosure is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A camera module, comprising:
a main body;
a lens module comprising a cable connected to the main body; and
a connecting member mounted between the main body and the lens module;
wherein a cable position structure is formed on the connecting member for positioning the cable.

2. The camera module of claim 1, wherein the connecting member comprises a front plate and a side plate extending rearward from a side of the front plate, the cable position structure is formed on the side plate.

3. The camera module of claim 2, wherein the cable position structure comprises an indentation defined in the side plate and extending through a rear surface of the side plate, a supporting plate extending out from an inner surface of the indentation, and a flange extending rearward from an outer side of the supporting plate away from the front plate, the supporting plate, the flange, and the side plate cooperatively bound a receiving slot for positioning the cable.

4. The camera module of claim 3, wherein the receiving slot communicates with the indentation.

5. The camera module of claim 2, wherein the front plate defines a circular opening, an inner wall bounding the opening defines internal threads, the lens module comprises a tube-shaped connecting portion extending rearward from the lens module, wherein the connecting portion defines external threads mating with the internal threads of the connecting member.

6. The camera module of claim 2, wherein the front plate defines a plurality of mounting holes, a plurality of screws extends through the plurality of mounting holes, and is screwed to the main body.
